(19) United States
(12) Patent Application Publication
(10) Pub. No.: US 2025/0111268 A1
(43) Pub. Date: Apr. 3, 2025

(54) LABEL DENOISING APPROACH VIA EMBEDDINGS AND PROBABILITIES

(71) Applicant: Dell Products L.P., Round Rock, TX (US)

(72) Inventor: Rômulo Teixeira de Abreu Pinho, Niterói – RJ (BR)

(21) Appl. No.: 18/478,834

(22) Filed: Sep. 29, 2023

(51) Int. Cl. G06N 20/00

(52) U.S. Cl. CPC G06N 20/00

(57) ABSTRACT

One example method includes training a model using training data that includes data samples, and the ML model has no awareness as to which labels of the data samples are correct, and which labels of the data samples are incorrect, projecting the training data onto an embedding space, identifying data samples that have been correctly labeled by the model, setting aside data samples that have been mislabeled by the model, applying a probability density function to data samples that have been correctly labeled by the model, for each of the mislabeled data samples, determining a likelihood of the mislabeled data sample belonging to a class that is included in a group of classes, and a class that yields the highest likelihood, with a highest confidence score, is taken as a correct label for that mislabeled data sample, and adding the data samples that have been mislabeled to the training data.

### FIELD OF THE INVENTION

Embodiments of the present invention generally relate to supervised learning approaches for ML (machine learning) models. More particularly, at least some embodiments of the invention relate to systems, hardware, software, computer-readable media, and methods, for denoising labels associated with samples of a training dataset used for training an ML model.

### BACKGROUND

A large portion of machine learning (ML) solutions used in classification tasks today is based on supervised learning approaches. Such approaches depend on large amounts of labelled data to work. Labelled data refers to the idea that the outcome the ML solution is expected to learn is given for most, if not all, of the data used in the ML training process. For instance, each image in the MNIST data set (see Deng, L., 2012. The MNIST database of handwritten digit images for machine learning research. IEEE Signal Processing Magazine, 29 (6), pp. 141-142) is associated with a label indicating the number to which the image corresponds. As another example, each image in the ImageNet data set (see Deng, J. et al., 2009. Imagenet: A large-scale hierarchical image database. In 2009 IEEE conference on computer vision and pattern recognition. pp. 248-255) is associated with a label indicating the class to which the image belongs, such as dog, cat, or bird, for example). Similarly, each text sentence in the Stanford Sentiment Treebank (Socher, R., Perelygin, A., Wu, J., Chuang, J., Manning, C. D., Ng, A., & Potts, C. (2013). Recursive Deep Models for Semantic Compositionality Over a Sentiment Treebank. Conference on Empirical Methods in Natural Language Processing) is associated with a score indicating its positiveness or negativeness, that is, the sentiment). The data labels may also be referred to as the “ground truth” used in the ML training process, because the labels are known to be correct.

While valuable when used in creating training data sets for an ML model, labelling is a very expensive process that typically requires human annotators. A considerable challenge in any supervised learning approach is obtaining good quality data that can be used for ML training. As data set sizes and complexities increase, along with the complexity of the ML task itself, it becomes more difficult to generate properly labelled data. A common problem observed in poor-quality data sets is that of so-called ‘noisy’ labels.

Noise in data labels means that a sample of a data set is unintentionally associated with an unexpected, or incorrect, label. For example, a label may be characterized as noisy if that label identifies an image of a dog as ‘cat’, or if a positive text sentence received a negative score. A problem with mislabeling is that ML models using noisy labels may fail to learn the correct relationships between images and classes, sentences and sentiment scores, or, more generally, relationships between inputs and expected outcomes. This renders the ML solution less effective, and risky, since incorrect inferences may be generated by the ML model based on the mislabeled data.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses aspects of an architecture of an ML model according to an embodiment of the invention.

FIG. 2 discloses aspects of an example transformation of data points onto a 1D embedding space, according to an embodiment of the invention.

FIGS. 3A and 3B disclose an example label denoising algorithm according to an embodiment of the invention.

FIG. 4 discloses an example method according to an embodiment of the invention.

FIG. 5 discloses an example computing entity operable to perform an of the disclosed methods, processes, operations, and algorithms.

### DETAILED DESCRIPTION OF SOME EXAMPLE EMBODIMENTS

Embodiments of the present invention generally relate to supervised learning approaches for ML (machine learning) models. More particularly, at least some embodiments of the invention relate to systems, hardware, software, computer-readable media, and methods, for denoising labels associated with samples of a training dataset used for training an ML model, which may also be referred to herein simply as a ‘model.’

One example embodiment of the invention comprises an approach to deal with noisy labels that may be applicable in any modelling setting. The approach comprises projecting input data samples, that is, data samples of a training dataset input for use in training an ML model, onto an embedding space, and then probabilistically identifying the mislabeled data samples. A label correction step is executed, and the train-identify-correct steps are repeated until convergence is achieved.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment of the invention is that the operation of an ML model may be improved, at least in terms of accuracy and/or effectiveness of the output of the ML model, through the use of correctly labeled training data. An embodiment may automatically generate correct labels for data without requiring the use of human-applied annotations to the data. An embodiment may generate labels for data more quickly than if the labels were determined by a human. An embodiment may reduce the expense associated with generating labels, relative to the expense that would be incurred if the labels were generated by a human. An embodiment may improve the quality of an ML model training dataset relative to training datasets that include mislabeled data. Various other advantages of one or more example embodiments of the invention will be apparent from this disclosure.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

### A. Overview of an Example Embodiment of the Invention

One example embodiment comprises a combination of techniques that fall into the class of probabilistic methods with label refurbishment, as defined, for example, in “Song, H., Kim, M., Park, D., Shin, Y., & #38; Lee, J.-G. (2020). Learning from Noisy Labels with Deep Neural Networks: A Survey. 2, 1-19. http://arxiv.org/abs/2007.08199,” incorporated herein in its entirety by this reference.

In an embodiment, a given ML model architecture may be trained to completion, with its training input data, without any knowledge about which labels of the training data are correct and which are not. The only assumption that may be made is that the ML model architecture provides a transformation layer that is trained to project the input data onto an embedding space. Such embedding corresponds to a vectorial representation of the input data in a lower dimensional space. This representation may be provided to a decision, or classifier, function that separates data samples into target classes, that is, labels. In neural network (NN) based architectures, for example, the transformation layer is the last one before the softmax, which converts a vector of K real numbers into a probability distribution of K possible outcomes, or sigmoid, or similar, function that is applied to assign a probability of a data sample belonging to each output class.

After training of the ML model is completed, the training data samples are projected onto the embedding space via the transformation layer of the ML model and all mislabeled samples, according to the assignments made by the trained ML model, are set aside. A probability density function (PDF) is then fit to the correctly labelled samples of each class. Next, the likelihood of each mislabeled sample belonging to each class is computed based on the fitted PDFs. The class that yields the highest likelihood with high confidence is assumed to be the one that represents the correct label of the sample. Consequently, such label is assigned to the sample as its “new” ground truth and all corrected samples are tracked.

After this process, the mislabeled samples are reincorporated into the training set and the ML model training restarts from scratch. The train-identify-correct rounds are repeated until a convergence criterion is satisfied, which, in one embodiment, is when the number of corrected samples is below a given threshold, or when a maximum number of iterations is achieved.

Advantageously, the use of the embedding space of a trained ML model may yield the best separation of the data, so that the decision function correctly assigns label probabilities to data samples. In addition, embedding spaces typically have much lower dimensionality than the input data, making the PDF fitting step much lighter, in terms of computational burden, than it would be with the original data.

### B. Detailed Discussion of an Example Embodiment of the Invention

Assume a supervised data classification ML model that learns a mapping function y=f(x|Θ), x∈ [symbol] ^{d}, y∈ [symbol] , where [symbol] is a set of class labels to which input values x are mapped, and Θ are model parameters. Suppose the ML model learns f(.) via a training set with N data points [symbol] ={(xi, yi), i∈[1 . . . . N]} for which the class label yi is known for sample xi.

As noted earlier herein, conventional approaches by which class labels are assigned to training data points, may be prone to errors, leading to many data points receiving the incorrect label without any notice. As a result, it is not possible to know a priori which labels are correct and which are not.

During training of the ML model, an optimization process causes the model parameters Θ to adjust in such a way to minimize a distance measure between the class label yielded by the model, ŷ, and the true label, y. Mislabeled data points may lead to suboptimal, or even incorrect, ML model training results because the optimization process will make the parameters of the model converge to a configuration that will likely assign incorrect class labels to unseen data, that is, data received by the ML model when the ML model is deployed in production.

Mislabeled data points are treated as noise in the data. Robust model training approaches try to identify them and take actions that mitigate their influence on the training process. Some approaches choose to remove the noisy data points before training. Other approaches try to modify the optimization process in such a way to minimize the influence of noise in the data.

Rather than remove mislabeled data points, as in conventional approaches, an example embodiment of the invention comprises an approach that may identify which class label is the correct one for a data point, and then relabel the mislabeled data points with the correct labels. In an embodiment, this label change procedure may be implemented before, or during, training of the ML model. An example embodiment comprises a denoising technique that relies on train-identify-relabel rounds to achieve good results.

### B.1 Model Architecture and Data Transformations

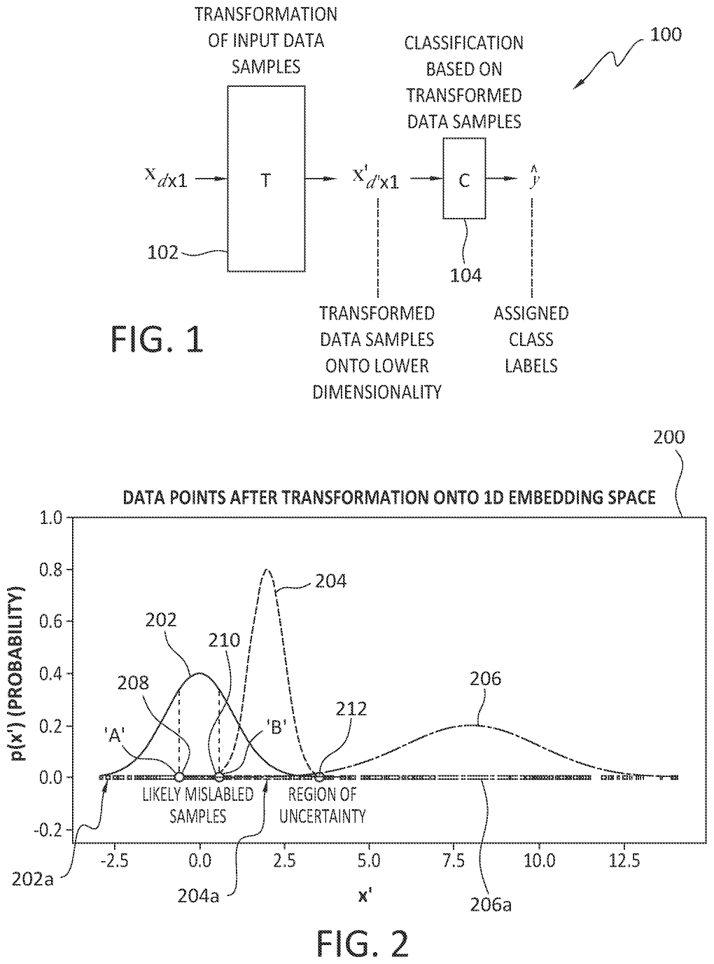

With reference now to FIG. 1, an example architecture is disclosed of an ML model 100 according to one embodiment of the invention. As shown in the example of FIG. 1, the architecture of the ML model 100 may be considered as comprising two parts. The first part 102 transforms the original data points, X_{d×1}, into another representation, x′_{d′×1}, where, typically, d′<d. This new representation may be referred to as an embedding of the input data into a new space. This first part 102 may be referred to herein as a transformer T.

The second part 104 of the ML model 100 receives the transformed data point(s) from the first part 102, that is, the transformer T, and assigns a probability value of the point belonging to each of the possible output classes. Such probability values may be further processed but, in general, the class label with the highest value may be the one assigned to the sample. This second part 104 may be referred to herein as a classifier C. The ML model 100 architecture may comprise that of a DNN (Deep Neural Network), but that is not a requirement for any particular embodiment of the invention. Of significance with respect to the architecture disclosed in FIG. 1 is that once the ML model 100 has been fully trained, the first part 102, or transformer T, may embed the input data into a new space, such as a latent space for example, where it may be easier to separate the data points into classes.

### B.2 PDFs in Embedded Spaces

An embodiment of the invention may identify the noisy labels on the embedded space where points x′ lie. We do this by fitting a probability density function (PDF) onto the subsets of points corresponding to each annotated classes label. Namely, each class label will correspond to one PDF. The choice of the PDF to be fitted onto the data may depend on some domain knowledge or collected statistics. Without loss of generality, we assume the PDF to be a Gaussian function.

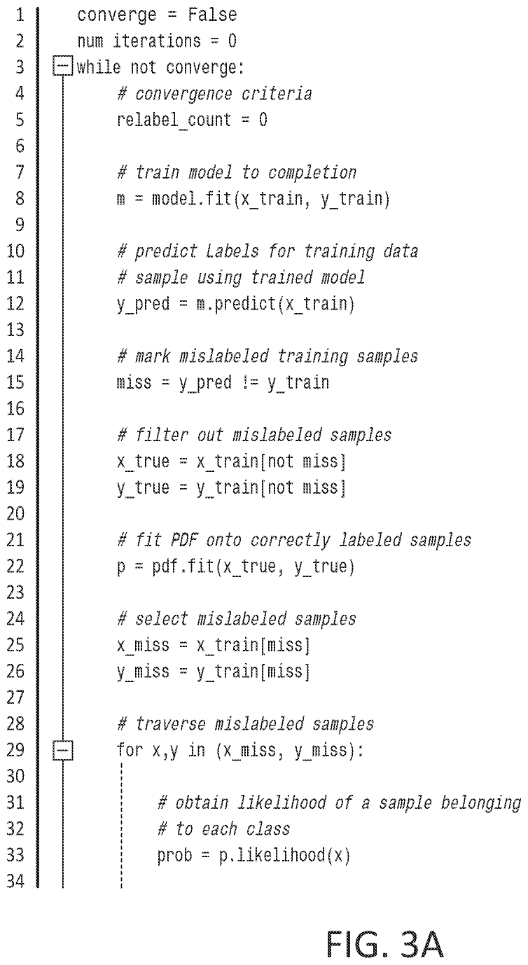

With reference now to FIG. 2, an example is disclosed of labeled data points embedded into a one-dimensional space and their respective (Gaussian) PDFs. In particular, FIG. 2 comprises a graph 200 indicating how the transformer T (first part 102) has embedded data points into a one-dimensional space. In the example, there are three classes, respectively, 202, 204 and 206, and the respective points x′ 202a, 204a, and 206a, associated with each class label are distributed across the horizontal X-axis according to a Gaussian function. The functions representing the Gaussian distributions are plotted with solid lines.

With continued reference to FIG. 2, the relatively larger dots on the X-axis represent data points annotated with class label yi, but the model, after being trained, assigned label ŷⱼ, j≠i, to them. For the dot 208 on the left, the assigned label was ‘A,’ while the dot 210 on the right was assigned label ‘B.’ Note that the two points 208 and 210 on the left lie in a region of the embedded one-dimensional space where points corresponding to 202 have a high probability of occurring, according to the fitted PDF. This might be an indication that those points 208 and 210 were annotated with the wrong labels when the data was collected for model training. The point 212 on the right, on the other hand, lies in a region of the embedded space where there is uncertainty about what the correct label may be, that is, the point 212 may belong to any of class 202, 204, or 206. Thus, it may not be clear whether any mislabeling of point 212 has occurred. The question then becomes how to differentiate between these cases.

### B.3 Label Denoising Algorithm

As mentioned above, mislabeled data points may bias the optimization process in such a way that ML model parameters converge to suboptimal, or even incorrect, configurations, which leads to poor classification performance by the ML model. If those points are identified and relabeled with likely correct class labels, “point x class” relationships are strengthened, and the ML model can better learn how to correctly separate data points into classes.

To increase the chances of identifying mislabeled data samples, an embodiment of the invention may train the model with one or more train-identify-relabel rounds. In the initial ‘train’ operation, the ML model is trained as usual, using a training set [symbol] , without the ML model having any knowledge about whether the data in the training set [symbol] contain mislabeled points. In the ‘identify’ operation, an embodiment may obtain predicted class labels, ŷi, for the data points in [symbol] and set aside all incorrectly assigned points, ε|yi≠ŷi, thereby generating a new data set [symbol] ′= [symbol] −ε.

Next, the PDFs may be fit onto the points in [symbol] ′, grouped by class labels, so that a result like the example in FIG. 2 may be obtained, but in the dimensionality defined by the transformer T, that is, the first part 102. In an embodiment, this fitting may be achieved, for example, by a maximum likelihood estimation method. The reasoning behind fitting the PDFs onto [symbol] ′ is that an embodiment may avoid uncertainties in process by considering only those points for which the trained ML model yielded correct class predictions.

After fitting the PDFs, an embodiment of the invention may compute the likelihood of each point from the misclassified set, ε, relative to each class distribution. This is like a train-test validation process, in which the training set for PDF fitting is [symbol] ′ and the test set is ε. The likelihood values may be further normalized using a softmax function, for example, so that differences between likelihoods are exponentially potentialized. The class yielding the highest softmax score may thus be the class that should have been assigned to the data point, that is, the correct class for that data point.

It is noted that while the aforementioned procedure works in general, it may fail in regions of uncertainty in-between data point distributions, such as the example region of uncertainty indicated in FIG. 2. To remediate this, an embodiment of the algorithm may comprise the computation of a confidence score that is used to guarantee that a data point is tagged as mislabeled only if the confidence score associated with the applied label is above a given threshold, T1. In an embodiment, the confidence score may be calculated via a normalized metric between the highest softmax score obtained in the step above and the mean score of the remaining values, namely:

$$confidence = ( ( max\_likelihood - unlikely\_mean ) / ( max\_likelihood ) ) ∈ [ 0 , 1 ]$$

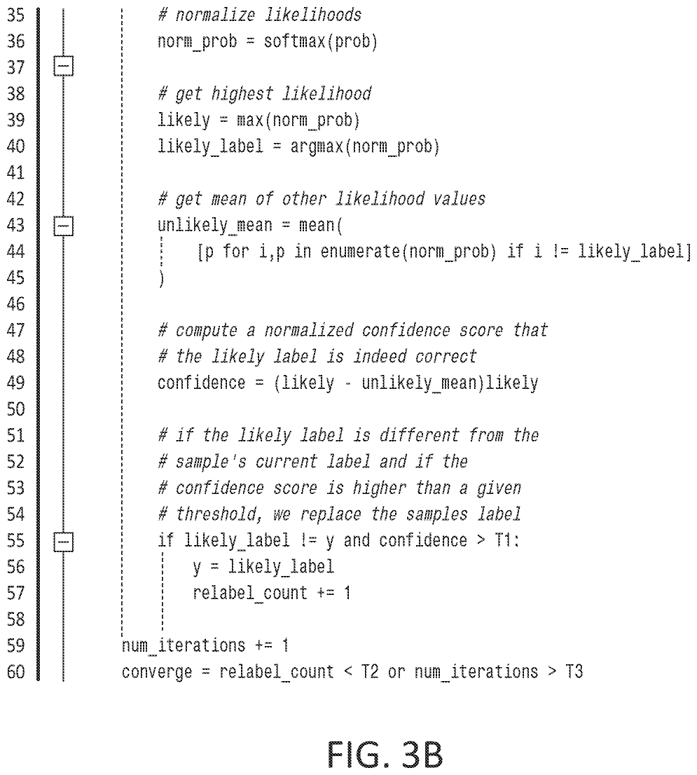

If the class label corresponding to max_likelihood, ŷ′, is different from the one the ML model assigned to the data point, y, and if confidence>T1, then the data point is relabeled. All points in ε (relabeled or unmodified) may then be merged with [symbol] ′ to form an updated set [symbol] =εU [symbol] ′. A new train-identify-relabel round may then start. This process may be repeated until the total number of relabeled points is below a threshold, T2, or when a maximum number of iterations, T3, is achieved. The details of an example algorithm 300 for a train-identify-relabel process according to one embodiment of the invention, comprising commented Python-like pseudocode, can be found in FIGS. 3A and 3B.

### C. Example Methods

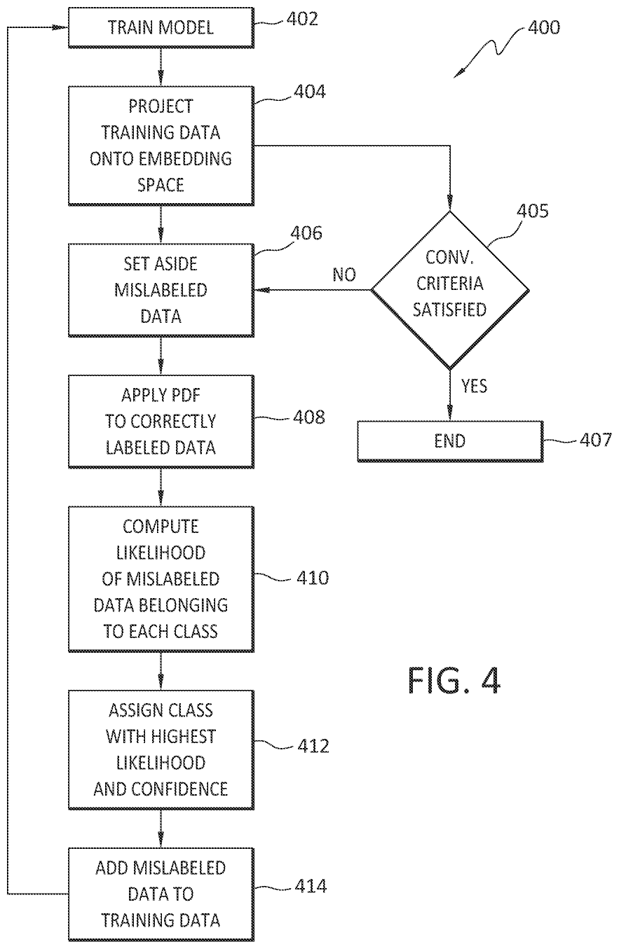

It is noted with respect to the disclosed methods, including the example method of FIG. 4, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Directing attention now to FIG. 4, an example method according to one embodiment is referenced at 400. In an embodiment, the method 400 may be performed in whole or in part by an ML model.

The example method 400 may begin with training 402, to completion, an ML model. The data used in the training 402 may include both correctly labeled data, and mislabeled data, although during the training 402, the ML model has no knowledge or awareness that the training data includes mislabeled data.

After the training 402 is completed, the training data samples may be projected 404 onto an embedding space, such as by way of a transformation layer of the ML model. At this stage, a check 405 may be performed to determine whether or not a convergence criterion/criteria has/have been met. For example, if it is determined, after the projection 404, that the number of mislabeled data samples is below a given threshold, then the method 400 may stop 407. As another example, if it is determined, at 405, that a maximum number of ‘n’ iterations of the method 400 have been performed, the method may end 407. In an embodiment, the method 400 may end 407 after whichever of the two aforementioned criteria is satisfied first.

If it is determined 405 that the convergence criterion/criteria has/have not been met, the method 400 may proceed to 406 where any mislabeled data identified as a result of the projecting 404 may be set aside. Next, a probability density function may be fit 408 to the remaining, correctly labeled, samples of each of the classes of data.

The likelihood of each of the mislabeled data samples, previously set aside 406, may then be computed 410 based on the fitted PDFs. For each mislabeled sample, the class that yields the highest likelihood, with confidence that meets or exceeds an established threshold, is assumed to be the one that represents the correct label for that sample, and that class is assigned 412 to that sample.

After the mislabeled samples have been labeled 412, they may then be reincorporated 414 into the training dataset. The method 400 may then return to 402 for another iteration.

### D. Further Example Embodiments

Following are some further example embodiments of the invention. These are presented only by way of example and are not intended to limit the scope of the invention in any way.

Embodiment 1. A method, comprising operations including: training a machine learning (ML) model to completion using training data that comprises data samples, wherein the ML model has no awareness as to which labels of the data samples are correct, and which labels of the data samples are incorrect; projecting the training data onto an embedding space; identifying those data samples that have been correctly labeled by the ML model; setting aside any data samples that have been mislabeled by the ML model; applying a probability density function to data samples that have been correctly labeled by the ML model; for each of the mislabeled data samples, determining a likelihood of the mislabeled data sample belonging to a class that is included in a group of classes, wherein a class that yields the highest likelihood, with a highest confidence score, is taken as a correct ground truth label for that particular mislabeled data sample; and adding the data samples that have been mislabeled back to the training data.

Embodiment 2. The method as recited in any preceding embodiment, wherein the operations are performed iteratively until a maximum number of iterations is reached and/or when a corrected number of data samples falls below a threshold.

Embodiment 3. The method as recited in any preceding embodiment, wherein the projecting of the training data onto the embedding space is performed by the ML model using a transformation layer of the ML model.

Embodiment 4. The method as recited in any preceding embodiment, wherein the embedding reduces a dimensionality of the training data.

Embodiment 5. The method as recited in any preceding embodiment, wherein, prior to projecting the training data onto an embedding space, the ML model transforms the training data.

Embodiment 6. The method as recited in any preceding embodiment, wherein the ML model transforms the training data to create transformed data, such that the mislabeled data samples and the correctly labeled data samples comprise respective portions of the transformed data.

Embodiment 7. The method as recited in any preceding embodiment, wherein the embedding space has a dimensionality that is less than a dimensionality of the training data.

Embodiment 8. The method as recited in any preceding embodiment, wherein a respective probability density function is fitted onto the data samples associated with each different label assigned by the ML model.

Embodiment 9. The method as recited in any preceding embodiment, wherein the probability density function comprises a Gaussian function.

Embodiment 10. The method as recited in any preceding embodiment, wherein the confidence score ensures that a data sample is identified as having been mislabeled only if the confidence score exceeds a given threshold.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### E. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

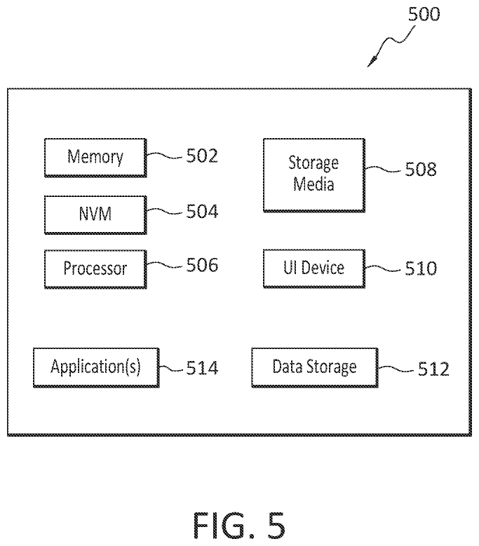

With reference briefly now to FIG. 5, any one or more of the entities disclosed, or implied, by FIGS. 1-4, and/or elsewhere herein, may take the form of, or include, or be implemented on, or hosted by, a physical computing device, one example of which is denoted at 500. As well, where any of the aforementioned elements comprise or consist of a virtual machine (VM), that VM may constitute a virtualization of any combination of the physical components disclosed in FIG. 5.

In the example of FIG. 5, the physical computing device 500 includes a memory 502 which may include one, some, or all, of random access memory (RAM), non-volatile memory (NVM) 504 such as NVRAM for example, read-only memory (ROM), and persistent memory, one or more hardware processors 506, non-transitory storage media 508, UI device 510, and data storage 512. One or more of the memory components 502 of the physical computing device 500 may take the form of solid state device (SSD) storage. As well, one or more applications 514 may be provided that comprise instructions executable by one or more hardware processors 506 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising operations including:
training a machine learning (ML) model to completion using training data that comprises data samples, wherein the ML model has no awareness as to which labels of the data samples are correct, and which labels of the data samples are incorrect;
projecting the training data onto an embedding space;
identifying those data samples that have been correctly labeled by the ML model;
setting aside any data samples that have been mislabeled by the ML model;
applying a probability density function to data samples that have been correctly labeled by the ML model;
for each of the mislabeled data samples, determining a likelihood of the mislabeled data sample belonging to a class that is included in a group of classes, wherein a class that yields a highest likelihood, with a highest confidence score, is taken as a correct ground truth label for that particular mislabeled data sample; and
adding the data samples that have been mislabeled back to the training data.

2. The method as recited in claim 1, wherein the operations are performed iteratively until a maximum number of iterations is reached and/or when a corrected number of data samples falls below a threshold.

3. The method as recited in claim 1, wherein the projecting of the training data onto the embedding space is performed by the ML model using a transformation layer of the ML model.

4. The method as recited in claim 1, wherein the embedding reduces a dimensionality of the training data.

5. The method as recited in claim 1, wherein, prior to projecting the training data onto an embedding space, the ML model transforms the training data.

6. The method as recited in claim 1, wherein the ML model transforms the training data to create transformed data, such that the mislabeled data samples and the correctly labeled data samples comprise respective portions of the transformed data.

7. The method as recited in claim 1, wherein the embedding space has a dimensionality that is less than a dimensionality of the training data.

8. The method as recited in claim 1, wherein a respective probability density function is fitted onto the data samples associated with each different label assigned by the ML model.

9. The method as recited in claim 1, wherein the probability density function comprises a Gaussian function.

10. The method as recited in claim 1, wherein the confidence score ensures that a data sample is identified as having been mislabeled only if the confidence score exceeds a given threshold.

11. A non-transitory storage medium having stored therein instructions that are executable by one or more hardware processors to perform operations comprising:
training a machine learning (ML) model to completion using training data that comprises data samples, wherein the ML model has no awareness as to which labels of the data samples are correct, and which labels of the data samples are incorrect;
projecting the training data onto an embedding space;
identifying those data samples that have been correctly labeled by the ML model;
setting aside any data samples that have been mislabeled by the ML model;
applying a probability density function to data samples that have been correctly labeled by the ML model;
for each of the mislabeled data samples, determining a likelihood of the mislabeled data sample belonging to a class that is included in a group of classes, wherein a class that yields a highest likelihood, with a highest confidence score, is taken as a correct ground truth label for that particular mislabeled data sample; and
adding the data samples that have been mislabeled back to the training data.

12. The non-transitory storage medium as recited in claim 11, wherein the operations are performed iteratively until a maximum number of iterations is reached and/or when a corrected number of data samples falls below a threshold.

13. The non-transitory storage medium as recited in claim 11, wherein the projecting of the training data onto the embedding space is performed by the ML model using a transformation layer of the ML model.

14. The non-transitory storage medium as recited in claim 11, wherein the embedding reduces a dimensionality of the training data.

15. The non-transitory storage medium as recited in claim 11, wherein, prior to projecting the training data onto an embedding space, the ML model transforms the training data.

16. The non-transitory storage medium as recited in claim 11, wherein the ML model transforms the training data to create transformed data, such that the mislabeled data samples and the correctly labeled data samples comprise respective portions of the transformed data.

17. The non-transitory storage medium as recited in claim 11, wherein the embedding space has a dimensionality that is less than a dimensionality of the training data.

18. The non-transitory storage medium as recited in claim 11, wherein a respective probability density function is fitted onto the data samples associated with each different label assigned by the ML model.

19. The non-transitory storage medium as recited in claim 11, wherein the probability density function comprises a Gaussian function.

20. The non-transitory storage medium as recited in claim 11, wherein the confidence score ensures that a data sample is identified as having been mislabeled only if the confidence score exceeds a given threshold.
